(19) United States
(12) Patent Application Publication
(10) Pub. No.: US 2017/0180796 A1
(43) Pub. Date: Jun. 22, 2017

(54) METHOD FOR IMPROVING COMPATIBILITY BETWEEN SMART TELEVISION AND EMBEDDED MULTI MEDIA CARD, AND ELECTRONIC DEVICE

(71) Applicants: Le Holdings (Beijing) Co., Ltd., Beijing (CN); LE SHI ZHI XIN ELECTRONIC TECHNOLOGY (TIANJIN) LIMITED, Tianjin (CN)

(72) Inventor: Senlin Dong, Tianjin (CN)

(21) Appl. No.: 15/237,644

(22) Filed: Aug. 16, 2016

Related U.S. Application Data
(63) Continuation of application No. PCT/CN2016/088676, filed on Jul. 5, 2016.

(30) Foreign Application Priority Data
Dec. 21, 2015 (CN) 201510961813.1

(51) Int. Cl. H04N 21/443; H04N 21/242; H04N 21/43; H04N 21/61

(52) U.S. Cl. CPC H04N 21/4432; H04N 21/6125; H04N 21/6175; H04N 21/242; H04N 21/4302

(57) ABSTRACT

Disclosed is a method for improving compatibility between a smart television and an embedded multi media card and an electronic device. The method includes: when the smart television is powered up, an operating mode of the smart television is obtained; when the operating mode is a non-user mode, a checking step is performed; and a processor of the smart television transmits a clock and data phase checking command to the embedded multi media card. The disclosure is determined according to the operating mode of the smart television, and is contrived in view of reducing impact on the user, thereby performing reading timing sequence calibration between the processor and an eMMC chip when the smart television is in the non-user mode, in this way, the compatibility between the processor and the eMMC chip may be enhanced, and at the same time, the startup and boot-up time can not be affected.

### CROSS REFERENCE TO RELATED APPLICATIONS

This application is a continuation application of International Application No. PCT/CN2016/088676 filed on Jul. 5, 2016, which claims priority to Chinese Patent Application No. 201510961813.1, titled “METHOD FOR IMPROVING COMPATIBILITY BETWEEN SMART TELEVISION AND EMBEDDED MULTI MEDIA CARD, AND SMART TELEVISION”, filed on Dec. 21, 2015, the entire contents of which are incorporated herein by reference.

### TECHNICAL FIELD

The disclosure relates to the field of the related art of a smart television, and particularly to a method for improving compatibility between a smart television and an embedded multi media card and an electronic device.

### BACKGROUND

An embedded multi media card (eMMC) is of an embedded memory standard specification made by a Multi Media Card (MMC) association, and is mainly designed for a mobile phone. One obvious advantage of the embedded multi media card or a chip referred to as eMMC is that one controller is integrated in a package, which provides a standard interface and manages a flash memory, such that a smart television manufacturer can focus on other portions of product development, and shortens the time of launching a product in the market. These characteristics are of importance as well for a NAND supplier intending to lower the cost by decreasing a photoetching size. A structure of the eMMC consists of an embedded storage solution, and is provided with a MMC (multi media card) interface, a quick flash memory device and a main controller, all of which are in a small BGA package. The interface has a speed up to 52 MB per second, and the eMMC has performances of high speed and availability of upgrading. Memory chips currently used by the smart television are substantially eMMCs, and the communication between the processor of the smart television and the eMMC chip is realized mainly through data (Data), a clock (CLK) and a command (CMD). The inventor has found in a process of implementing the disclosure that some eMMC chips have a problem of low read-write speed, the reason for this is that different chips of the same batch from the same eMMC manufacturer are individually different, because the CLK is output by the processor and the Data is output by the eMMC. Accordingly, a certain delay may exist in high-speed data transmission, which results in mismatching in phase of the CLK and the Data and improper data sampling.

To address this problem, an operation of a 21st calibration command (CMD21 Command Tuning) is required in an eMMC specification; and by transmitting the CMD21 Command Tuning to the eMMC, the processor finds an optimal sampling point when the data is read. The operation of the CMD21 Command Tuning is required to be performed for 40 times at most and 150 ms at maximum.

During the realization of the disclosure, the inventors have found that there are at least questions existed as following: in order to increase a starting speed of a system, processors of some smart televisions use a standard read-write timing sequence now by default, without performing the operation of the CMD21 Command Tuning, which in this way causes a problem of low read-write speed when the processors of some smart televisions communicate with a certain eMMC chip, represented by low boot-up speed and jamming possibly existing in the system after boot-up.

### SUMMARY

In view of this, with respect to a technical problem of improper data sampling caused by mismatching in phase of a clock and data easily occurring when a processor of a smart television communicates with an eMMC chip in the prior art, it is necessary to provide a method for improving compatibility between a smart television and an embedded multi media card and an electronic device.

An embodiment of the disclosure provides a method for improving compatibility between a smart television and an embedded multi media card, including:
an operating mode obtaining step, including: when the smart television is powered up, an operating mode of the smart television is obtained;
an operating mode detecting step, including: when the operating mode is a non-user mode, a checking step is performed; and
a checking step, including: a processor of the smart television transmits a clock and data phase checking command to the embedded multi media card.

In another aspect, the embodiment of the disclosure provides a nonvolatile computer storage media having computer executable instructions stored thereon, wherein the computer executable instructions can perform the foregoing method for improving compatibility between a smart television and an embedded multi media card in the disclosure.

In further another aspect, the disclosure provides an electronic device, including: one or more processors; and a memory communication connected thereto; wherein, the memory is stored with instructions executable by the one or more processors, the instructions are configured to execute the foregoing method for improving compatibility between a smart television and an embedded multi media card in the disclosure.

The disclosure is determined according to the operating mode of the smart television, and is contrived in view of reducing impact on the user, thereby performing reading timing sequence calibration between the processor and an eMMC chip when the smart television is in the non-user mode, in this way, the compatibility between the processor and the eMMC chip may be enhanced, and at the same time, the startup and boot-up time can not be affected.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a work flow diagram of a method for improving compatibility between a smart television and an embedded multi media card according to some embodiments of the disclosure.

FIG. 2 is a work flow diagram of some embodiments according to the disclosure.

FIG. 3 is a module diagram of an electronic device according to some embodiments of the disclosure.

FIG. 4 is a schematic diagram of a structure of a hardware of the electronic device of the method for improving compatibility between a smart television and an embedded multimedia card according to some embodiments of the disclosure.

### DETAILED DESCRIPTION

The disclosure will be further described in detail below in conjunction with accompanying drawings and particular embodiments.

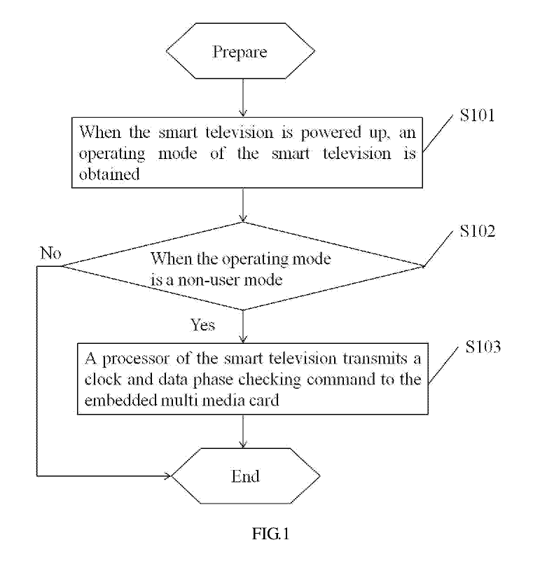

As shown in FIG. 1, it is a work flow diagram of a method for improving compatibility between a smart television and an embedded multi media card according to the embodiment of the disclosure. The method includes:
step S101, including: when the smart television is powered up, an operating mode of the smart television is obtained;
step S102, including: when the operating mode is a non-user mode, a step S103 is performed; and
step S103, including: a processor of the smart television transmits a clock and data phase checking command to the embedded multi media card.

In the step S101, the operating mode of the smart television is obtained, the operating mode is configured to indicate an operating condition of the smart television, different operating modes are indicated in a system of the smart television, and may be obtained by employing various existing manners. When the smart television is delivered to a user for use after leaving a factory, its operating mode may be set to a user mode, the non-user mode in the step S102 refers to a mode except for the user mode. If clock and data are checked in phase under the user mode, a problem of low startup speed of the user may easily result from a certain checking time, accordingly, in the disclosure, the step S103 is triggered only under the non-user mode for checking clock and data in phase, in this way, the compatibility between the processor and the eMMC chip may be enhanced, and at the same time, the startup and boot-up time can not be affected.

In one of the embodiments,
the step S102 further includes: when the operating mode is a user mode, a startup process is ended after a boot-up process is performed.

The step S103 further includes: upon completion of execution of the clock and data phase checking command, a startup process is ended after a boot-up process is performed.

When the operating mode is the user mode, to avoid affecting the use of the user, the clock and the data are not checked in phase, such that the user can obtain higher startup and boot-up time when normally using the smart television; and when the operating mode is the non-user mode, upon completion of execution of the clock and data phase checking command, the clock and the data are matched in phase, such that a boot-up process is relatively accurate, and mistakes are avoided.

In one of the embodiments, the clock and data phase checking command is a 21st calibration command of an embedded multi media card specification.

The 21st calibration command of an embedded multi media card specification is CMD21 Command Tuning in an eMMC specification, and may be well matched with all eMMC chips by employing the CMD21 Command Tuning.

In one of the embodiments,

The step S101 particularly includes: when the smart television is powered up, an environment variable stored in the embedded multi media card is obtained in a BootLoader executing phase, and the operating mode is obtained from the environment variable.

In an embedded operating system, the BootLoader runs before a kernel of the operating system runs, and may initialize a hardware device and establish a memory space mapping diagram, thereby bringing a software-hardware environment of the system to a suitable state for preparing a proper environment for finally calling the kernel of the operating system. The operating mode is detected in the BootLoader executing stage, so that the interference with the boot-up process by obtaining the operating mode in a normal boot-up process can be avoided.

In one of the embodiments, the non-user mode includes a factory mode debugged before the smart television leaves a factory, and the step S102 particularly includes:
a factory mode flag is obtained from the environment variable, and if the operating mode flag is set, it is determined that the operating mode is the factory mode, and the step S103 is performed.

The smart television runs one factory mode before leaving the factory, and is subject to some tests under the factory mode before leaving the factory. In this embodiment, the clock and data phase checking command is executed under the factory mode, and thereby the impact on the user is minimized.

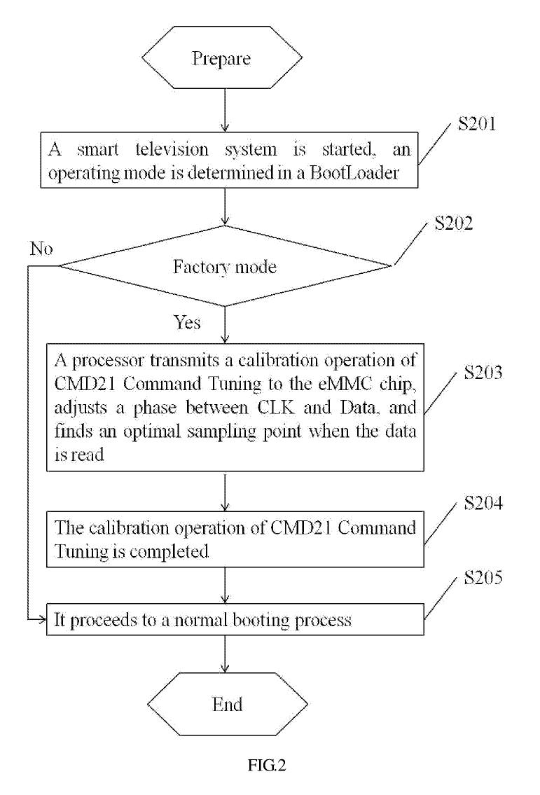

As shown in FIG. 2, it is a work flow diagram of an optimal embodiment according to the disclosure, including:

step S201. A smart television system is booted up, an operating mode is determined in a BootLoader, if the operating mode is a factory mode, it proceeds to step S202; otherwise if the operating mode is a user mode, it proceeds to step S204;

particularly, it is determined whether the smart television enters the factory mode or not by determining an environment variable “factory_mode” stored in an eMMC chip is 1 or not in a BootLoader stage of startup and boot-up;
step S202. The processor transmits a calibration operation of CMD21 Command Tuning to the eMMC chip, adjusts a phase between CLK and Data, and finds an optimal sampling point when the data is read;
step S203. When the calibration operation of CMD21 Command Tuning is completed, a step S204 is performed;
step S204. It proceeds to a normal boot-up process; and
step S205. The startup process is ended.

This embodiment is determined according to the operating mode of the smart television, and is contrived in view of reducing impact on the user, thereby performing reading timing sequence calibration between the processor and an eMMC chip when the smart television is in the non-user mode, in this way, the compatibility between the processor and the eMMC chip may be enhanced, and at the same time, the startup and boot-up time can not be affected.

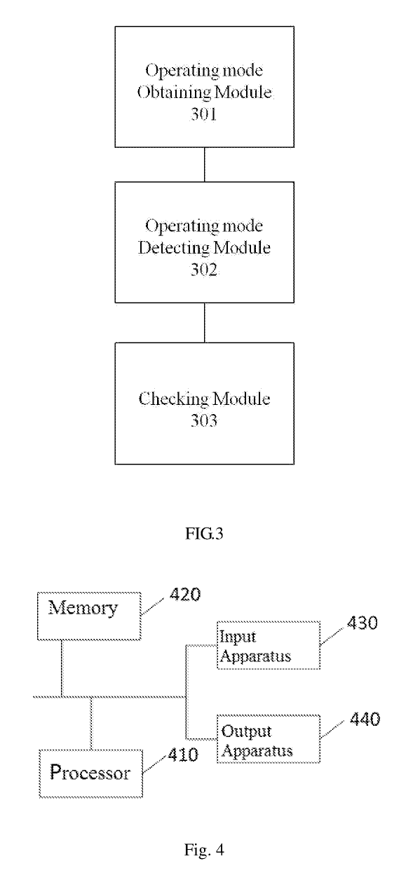

As shown in FIG. 3, it is a module diagram of a structure of en electronic device according to an embodiment of the disclosure wherein this electronic device includes:
an operating mode obtaining module 301, which is configured to, when the smart television is powered up, obtain an operating mode of the smart television;
an operating mode detecting module 302, which is configured to, when the operating mode is a non-user mode, perform a checking module; and
a checking module 303, which is configured to transmit, by a processor of the smart television, a clock and data phase checking command to the embedded multi media card.

The operating mode obtaining module 301 is configured to obtain an operating mode of the smart television, the operating mode is configured to indicate an operating condition of the smart television, different operating modes are indicated in a system of the smart television, and may be obtained by employing various existing manners. When the smart television is delivered to a user for use after leaving a factory, its operating mode may be set to a user mode, the non-user mode of the operating mode detecting module 302 refers to a mode except for the user mode. If clock and data are checked in phase under the user mode, a problem of low startup speed of the user may easily result from a certain checking time, accordingly, in the disclosure, the checking module 303 is triggered under the non-user mode for checking clock and data in phase, in this way, the compatibility between the processor and the eMMC chip may be enhanced, and at the same time, the startup and boot-up time can not be affected.

In one of the embodiments,
the operating mode detecting module 302 is further configured to: when the operating mode is a user mode, end a startup process after performing a boot-up process;
the checking module 303 is further configured to, upon completion of execution of the clock and data phase checking command, end a startup process after performing a boot-up process.

When the operating mode is the user mode, to avoid affecting the use of the user, the clock and the data are not checked in phase, such that the user can obtain higher startup and boot-up time when normally using the smart television; and when the operating mode is the non-user mode, upon completion of execution of the clock and data phase checking command, the clock and the data are matched in phase, such that a starting process is relatively accurate, and mistakes are avoided.

In one of the embodiments, the clock and data phase checking command is a 21st calibration command of an embedded multi media card specification.

The 21st calibration command of an embedded multi media card specification is CMD21 Command Tuning in an eMMC specification, and may be well matched with all eMMC chips by employing the CMD21 Command Tuning.

In one of the embodiments,
the operating mode obtaining module 301 is particularly configured to: when the smart television is powered up, obtain an environment variable stored in the embedded multi media card in a BootLoader executing phase, and obtain the operating mode from the environment variable.

In an embedded operating system, the BootLoader runs before a kernel of the operating system runs, and may initialize a hardware device and establish a memory space mapping diagram, thereby bringing a software-hardware environment of the system to a suitable state for preparing a proper environment for finally calling the kernel of the operating system. The operating mode is detected in the BootLoader executing stage, so that the interference with the boot-up process by obtaining the operating mode in a normal boot-up process can be avoided.

In one of the embodiments, the non-user mode includes a factory mode debugged before the smart television leaves a factory, and the operating mode detecting module 302 is particularly configured to:

obtain a factory mode flag from the environment variable, and if the operating mode flag is set, determine that the operating mode is the factory mode and execute a checking module.

The smart television runs one factory mode before leaving the factory, and is subject to some tests under the factory mode before leaving the factory. In this embodiment, the clock and data phase checking command is executed under the factory mode, and thereby the impact on the user is minimized.

An embodiment of the disclosure provides a nonvolatile computer storage media having computer executable instructions stored thereon, wherein the computer executable instructions can perform the method for improving compatibility between a smart television and an embedded multimedia card in any one of the foregoing embodiments of methods.

FIG. 4 is a schematic diagram of a structure of a hardware of the electronic device of the method for improving compatibility between a smart television and an embedded multi media card according to some embodiments of the disclosure, as shown in FIG. 4, this device includes:
one or more processors 410 and a memory 420, in FIG. 4, one processor 410 is employed as an example.

The device of the method for improving compatibility between a smart television and an embedded multimedia card may further comprise: an input apparatus 430 and an output apparatus 440.

The processor 410, the memory 420, the input apparatus 430 and the output apparatus 440 may be connected via a bus or other means, in FIG. 4, a connection via a bus is taken as an example.

As a nonvolatile computer readable storage media, the memory 420 can be used to store nonvolatile software program, nonvolatile computer executable program and module, such as the program instructions/modules corresponding to the method for improving compatibility between a smart television and an embedded multimedia card in the embodiments of the present application (e.g., the operating mode obtaining module 301, the operating mode detecting module 302 and the checking module 303 as shown in FIG. 3). The processor 410 executes various functions and applications of a server and data processing by running a nonvolatile software program, instructions and a module stored in the memory 420, so as to carry out the method for improving compatibility between a smart television and an embedded multi media card in the embodiments above.

The memory 420 may include a program storage area and a data storage area, wherein the program storage area can store an operating system, an application program required for at least one function; the data storage area can store the data created based on the use of the device for improving compatibility between a smart television and an embedded multi media card, or the like. Further, the memory 420 may include high-speed random access memory, and may further include nonvolatile memory, such as at least one disk storage device, flash memory device, or other nonvolatile solid-state memory devices. In some embodiments, the memory 420 optionally includes a memory remotely located with respect to the processor 410, which may be connected to an device for improving compatibility between a smart television and an embedded multi media card via a network. Examples of such network include, but not limited to, Internet, Intranet, local area network (LAN), mobile communication network, and combinations thereof.

The input apparatus 430 may receive the input numbers or characters information, as well as key signal input associated with user settings of the device for improving compatibility between a smart television and an embedded multi media card and function control. The output apparatus 440 may include a display screen or other display device.

The one or more modules are stored in the memory 420, and when being executed by the one or more processors 410, execute the method for improving compatibility between a smart television and an embedded multi media card in any one of the foregoing embodiments of methods

The above mentioned products can perform the method provided by the embodiments of the present application, and they have the function modules and beneficial effects corresponding to this method. With respect to the technical details that are not detailed in this embodiment, please refer to the methods provided by the embodiments of the present application.

The electronic device according to the embodiments of the present application may have many forms, for example, including, but not limited to:
(1) mobile communication device: the characteristic of such device is: it has the function of mobile communication, and takes providing voice and data communications as the main target. Such type of terminal includes: smart phones (for example iPhone), multimedia phones, feature phones and low-end mobile phones.
(2) ultra mobile PC device: this type of device belongs to the category of personal computer, it has the capabilities of computing and processing, and generally has the feature of mobile Internet access. Such type of terminal includes: PDA, MID and UMPC devices, such as iPad.
(3) portable entertainment device: this type of device can display and play multimedia content. Such type of device includes: audio players (for example iPod), video players, handheld game consoles, e-books, as well as smart toys and portable vehicle navigation devices.
(4) server: it provides computing services, and the structure of the server includes: a processor, a hard disk, a memory, a system bus and the like, its construction is similar to a general computer, but there is higher requirement on the processing capability, stability, reliability, security, scalability, manageability and other aspects of the server as highly reliable service is needed to provide.
(5) other electronic device that has the function of data exchange.

The apparatus of the above described embodiments are merely illustrative, and the unit described as separating member may or may not be physically separated, the component shown as a unit may be or may not be a physical unit, i.e., it may be located at one place, or it can be distributed to a plurality of network units. The aim of this embodiment can be implemented by selecting a part of or all of the modules according to the practical needs. And it can be understood and implemented by those of ordinary skill in the art without paying any creative work.

With reference to the above described embodiments, those skilled in the art can clearly understand that all the embodiments may be implemented by means of using software plus a necessary universal hardware platform, of course, they also be implemented by hardware. Based on this understanding, the above technical solution can be substantially, or the part thereof contributing to the prior art may be, embodied in the form of a software product, and the computer software product may be stored in a computer readable storage medium, such as ROM/RAM, magnetic disc, CD-ROM, or the like, which includes several instructions to instruct a computer device (may be a personal computer, server, or network equipment) to perform the method described in each embodiment or some parts of the embodiment.

Finally, it should be noted that: the above embodiments are merely provided for describing the technical solutions of the present invention, but not intended to limit thereto; although the present invention has been described in detail with reference to the foregoing embodiments, those skilled in the art will appreciate that: they can make modifications to the technical solutions described in the foregoing embodiments, or make equivalent replacements to some technical features thereof; and these modifications or replacements do not make the essence of corresponding technical solutions depart from the spirit and scope of the technical solution of each embodiment.

What is claimed is:

1. A method for improving compatibility between a smart television and an embedded multi media card, which is applied to a terminal, comprising:
an operating mode obtaining step, comprising: when the smart television is powered up, obtaining an operating mode of the smart television;
an operating mode detecting step, comprising: when the operating mode is a non-user mode, performing a checking step; and
a checking step, comprising: transmitting a clock and data phase checking command to the embedded multi media card by a processor of the smart television.

2. The method for improving compatibility between a smart television and an embedded multi media card according to claim 1, wherein
the operating mode detecting step further comprises: when the operating mode is a user mode, ending a startup process after executing a boot-up process; and
the checking step further comprises: after the clock and data phase checking command is completely executed, ending a startup process after performing a boot-up process.

3. The method for improving compatibility between a smart television and an embedded multi media card according to claim 1, wherein the clock and data phase checking command is a 21st calibration command of an embedded multi media card specification.

4. The method for improving compatibility between a smart television and an embedded multi media card according to claim 1, wherein
the operating mode obtaining step comprises: when the smart television is powered up, obtaining an environment variable stored in the embedded multi media card in a BootLoader executing phase, and obtaining the operating mode from the environment variable.

5. The method for improving compatibility between a smart television and an embedded multi media card according to claim 4, wherein the non-user mode comprises a factory mode debugged before the smart television leaves a factory, and the operating mode detecting step comprises:
obtaining a factory mode flag from the environment variable, and if the operating mode flag is set, determining that the operating mode is the factory mode and performing a checking step.

6. A nonvolatile computer storage media, which has computer executable instructions stored thereon, wherein the computer executable instructions are configured to:
an operating mode obtaining step, comprising: when the smart television is powered up, obtaining an operating mode of the smart television;
an operating mode detecting step, comprising: when the operating mode is a non-user mode, performing a checking step; and
a checking step, comprising: transmitting a clock and data phase checking command to the embedded multi media card by a processor of the smart television.

7. The nonvolatile computer storage media according to claim 6, wherein
the operating mode detecting step further comprises: when the operating mode is a user mode, ending a startup process after executing a boot-up process; and
the checking step further comprises: after the clock and data phase checking command is completely executed, ending a startup process after performing a boot-up process.

8. The nonvolatile computer storage media according to claim 6, wherein the clock and data phase checking command is a 21st calibration command of an embedded multi media card specification.

9. The nonvolatile computer storage media according to claim 6, wherein
the operating mode obtaining step particularly comprises: when the smart television is powered up, obtaining an environment variable stored in the embedded multi media card in a BootLoader executing phase, and obtaining the operating mode from the environment variable.

10. The nonvolatile computer storage media according to claim 9, wherein the non-user mode comprises a factory mode debugged before the smart television leaves a factory, and the operating mode detecting step comprises:
obtaining a factory mode flag from the environment variable, and if the operating mode flag is set, determining that the operating mode is the factory mode and performing a checking step.

11. An electronic device, comprising:
one or more processors; and,
a memory communicably connected with the at least one processor; wherein
the memory is stored with instructions executable by the one or more processors, and execution of the instructions by the at least one processor causes the at least one processor to execute:
an operating mode obtaining step, comprising: when the smart television is powered up, obtaining an operating mode of the smart television;
an operating mode detecting step, comprising: when the operating mode is a non-user mode, performing a checking step; and
a checking step, comprising: transmitting a clock and data phase checking command to the embedded multi media card by a processor of the smart television.

12. The electronic device according to claim 11, wherein
the operating mode detecting step further comprises: when the operating mode is a user mode, ending a startup process after executing a boot-up process; and
the checking step further comprises: after the clock and data phase checking command is completely executed, ending a startup process after performing a boot-up process.

13. The electronic device according to claim 11, wherein the clock and data phase checking command is a 21st calibration command of an embedded multi media card specification.

14. The electronic device according to claim 11, wherein
the operating mode obtaining step particularly comprises: when the smart television is powered up, obtaining an environment variable stored in the embedded multi media card in a BootLoader executing phase, and obtaining the operating mode from the environment variable.

15. The electronic device according to claim 14, wherein the non-user mode comprises a factory mode debugged before the smart television leaves a factory, and the operating mode detecting step particularly comprises:
obtaining a factory mode flag from the environment variable, and if the operating mode flag is set, determining that the operating mode is the factory mode and performing a checking step.
